(19) United States
(12) Patent Application Publication
(10) Pub. No.: US 2011/0179820 A1
(43) Pub. Date: Jul. 28, 2011

(54) Refrigerated Case

(75) Inventors: Luis F. Avila, Manlius, NY (US); Mark A. Daniels, Manlius, NY (US); Stephen Kenney, N Syracuse, NY (US); Martin C. Bezon, N Syracuse, NY (US)

(73) Assignee: CARRIER COMMERCIAL REFRIGERATION, INC., Charlotte, NC (US)

(21) Appl. No.: 12/521,220

(22) PCT Filed: Dec. 29, 2006
(86) PCT No.: PCT/US06/49583

§ 371 Date: Apr. 12, 2011

(51) Int. Cl. F25D 25/02; B23P 15/26

(52) U.S. Cl. 62/465; 29/890.035

(57) ABSTRACT

A refrigerated case includes a body having a left and a right side, a top, and a back. A refrigerated compartment is located within the body. A number of shelves are within the refrigerated compartment. A base compartment is below the refrigerated compartment. A dividing wall separates the base compartment from the refrigerated compartment. A refrigeration module is located within the base compartment. A support member intermediate to the left and right sides supports the shelves. A transverse beam supports the support member.

### BACKGROUND OF THE INVENTION

The invention relates to refrigerated cases. More particularly, the invention relates to such cases having multiple shelf arrays.

A basic refrigerated case (including freezers) is a narrow case with a single hinged door and a single vertical array of shelves. Multi-door refrigerated cases exist in many configurations. Some configurations include sliding doors whereas other configurations include hinged doors. Hinged-door refrigerated cases typically include a vertical mullion (post) between each pair of adjacent doors. Sliding door cases may mount doors in sliding pairs or other groupings. Such cases may typically have multiple vertical arrays of shelves (e.g., one array associated with each door).

In several configurations of refrigerated case, the refrigeration equipment is located in a self-contained module which may be installed to and removed from the case as a unit. An exemplary module includes the compressor, condenser, expansion device, evaporator, and associated fans. The module is typically installed in a base of the case below the refrigerated compartment. The module is typically installed to the base via rearward insertion through a front of the base. The insertion may be followed by a short lifting of the module to mate portions of the module forming the recirculating air flowpath with mating portions of the remaining structure of the case (e.g., and compressing a gasket/seal therebetween).

### SUMMARY OF THE INVENTION

One aspect of the invention involves a refrigerated case. The case includes a body having a left and a right side, a top, and a back. A refrigerated compartment is located within the body. A number of shelves are within the refrigerated compartment. A base compartment is below the refrigerated compartment. A dividing wall separates the base compartment from the refrigerated compartment. A refrigeration module is located within the base compartment. A support member intermediate to the left and right sides supports the shelves. A transverse beam supports the support member.

In various implementations, the beam may be embedded in the dividing wall. The module may be movable through a space below the beam.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a partially exploded view of a refrigerated case.

FIG. 2 is a partially cutaway view of a main body of the case of FIG. 1 with a refrigeration module shown in broken lines.

FIG. 3 is a longitudinal vertical sectional view of the case of FIG. 1.

FIG. 4 is a front view of the main body of the case of FIG. 1.

FIG. 5 is a partial enlarged cutaway view of a dividing wall of the case of FIG. 1.

FIG. 6 is a view of a beam of the dividing wall of FIG. 1.

FIG. 7 is an end view of an alternate beam.

Like reference numbers and designations in the various drawings indicate like elements.

### DETAILED DESCRIPTION

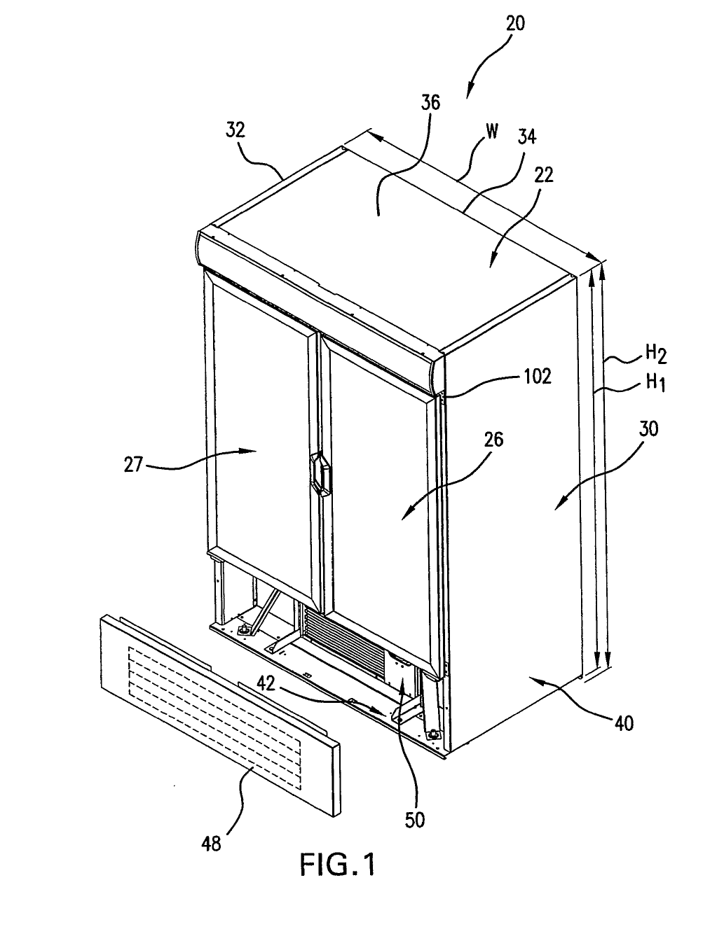

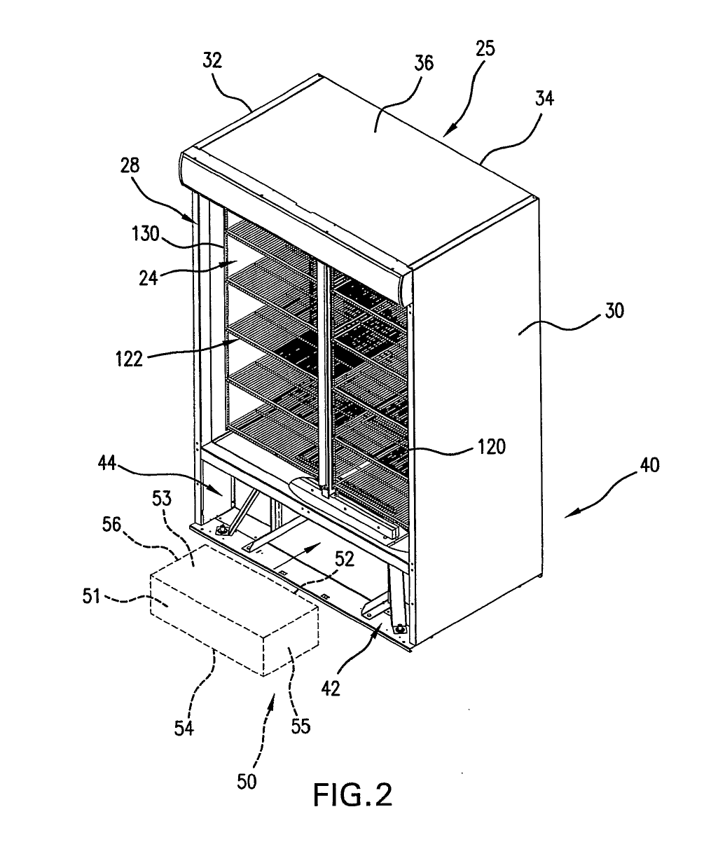

FIGS. 1-4 show a refrigerated case 20 having a housing (body) 22 surrounding a refrigerated interior compartment 24 (FIG. 2). The exemplary housing 22 includes a main body 25. Left and right doors 26 and 27 (FIG. 1) are positioned to close and open across a front opening 28 (FIG. 2) of the main body 25. The exemplary main body 25 has a left sidewall 30, a right sidewall 32, a back 34, and a top 36. For non-limiting reference, left and right are viewed from the perspective of the case rather than a user facing the case. A lower portion of the body 22 forms a base 40 including an exemplary platform 42. A base compartment 44 is separated from the compartment 24 by a compartment bottom wall (dividing wall) 46. A front of the compartment 44 may be closed by a removable grille 48. An overall case depth D is shown in FIG. 2. An overall case body height H₁, an overall case height H₂, and an overall case width W are shown in FIG. 1.

In the exemplary case 20, a recirculating airflow is directed from/to the compartment 24 by a refrigeration equipment module 50 (e.g., containing the compressor, heat exchangers, expansion device, fans, and the like). The module 50 (discussed in further detail below) has an installed position within the compartment 44. The module 50 is removable from the compartment 44 as a unit (e.g., after removing the grille 48, if present), advantageously without the use of tools or with only slight tool use. The exemplary module 50 (FIG. 2) has a front 51, a back 52, a top 53, a bottom 54, a left side 55, and a right side 56.

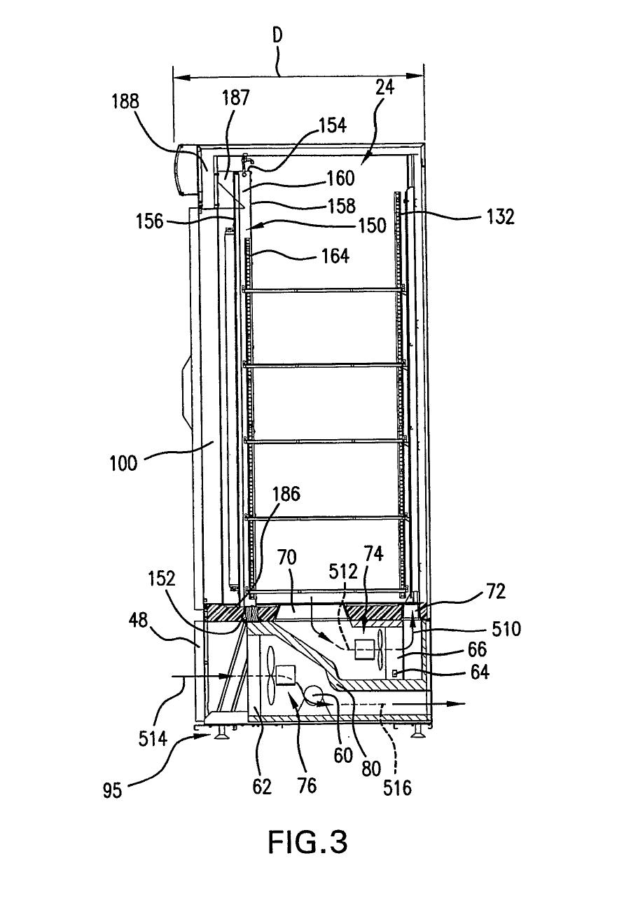

FIG. 3 shows further details of the exemplary case 20 and module 50. The exemplary module 50 contains the compressor 60, the heat rejection heat exchanger (e.g., condenser and/or gas cooler) 62, the expansion device 64, and the heat absorption heat exchanger (evaporator) 66 sequentially along a recirculating refrigerant flowpath (e.g., further defined by appropriate refrigerant lines/conduits). A recirculating airflow 510 passes along a recirculating flowpath (the cold air flowpath) 512 through the module 50 and compartment 24 to cool the compartment. The exemplary flow 510 passes from the compartment 24 into the module 50 through a first port 70 in the wall 46 and returns to the compartment 24 via a second port 72 in the wall 46. The exemplary flow 510 is driven by an electric fan 74 in the flowpath 512 in the module 50.

An airflow 514 passes along a flowpath (the warm air flowpath) 516 which extends through the heat rejection heat exchanger 62. Subject to considerations discussed further below, the exemplary path 516 is an open path entering through the grille 48, then entering the front 51 of the module 50 and passing through the heat rejection heat exchanger 62 before exiting the rear 52 of the module and rear of the case. An electric fan 76 may be in the warm air flowpath 516 in the module 50 to drive the airflow 514. A wall 80 may separate the flowpaths 512 and 516 within the module. Feet 95 or casters may support the case atop a ground/floor surface 96. As so far described, the case may be representative of a portion of the possible cases to which the present disclosure may be applied (e.g., to reengineer or further engineer a baseline case configuration).

The exemplary front opening 28 of the refrigerated compartment is divided by a vertical mullion (post) 100 (FIG. 3). In the exemplary case, the left and right doors 26 and 27 may selectively close the left and right portions of the opening on left and right sides of the mullion. The exemplary doors are hinged by hinges 102 (FIG. 1). The exemplary hinge locations are along the outboard edges of the doors joining the doors to the forward edges of the adjacent side walls. The doors may seal with the main body 25 along a face of the main body circumscribing a perimeter of the opening 28. This sealing may be via gaskets (e.g., a resilient magnetic gasket).

An alternative configuration has a sliding door unit (not shown). The sliding door unit may include one or more sliding doors mounted for movement on tracks of a frame.

The refrigerated compartment may contain one or more vertical arrays of shelves. Various mechanisms may be used to support the shelves. Full-width shelves may be supported by the left and right side walls (e.g., via pairs of front and rear vertical tracks along the wall inboard surfaces). The shelves may additionally or alternatively be supported by the back wall (e.g., via brackets mounted to the back wall). With relatively wide compartments, additional support may be appropriate. For example, full-width shelves may be subject to bowing. The full-width shelves may, advantageously, be supported front and/or back at a location intermediate the left and right side walls. Exemplary supports are vertical posts.

Alternatively, there may be more than one vertical shelf array. For example, in the exemplary case 20, there are left and right vertical arrays of shelves 120 and 122. The outboard edges of the shelves may be supported by tracks (e.g., a front track 130 (FIG. 2) and a rear track 132 (FIG. 3)) along the side walls. The inboard edges of the shelves may be supported by the intermediate support(s) (e.g., posts). Front and/or back intermediate supports may extend generally vertically within the compartment or along the compartment (e.g., embedded in the back wall or forming a front centerpost dividing the front opening).

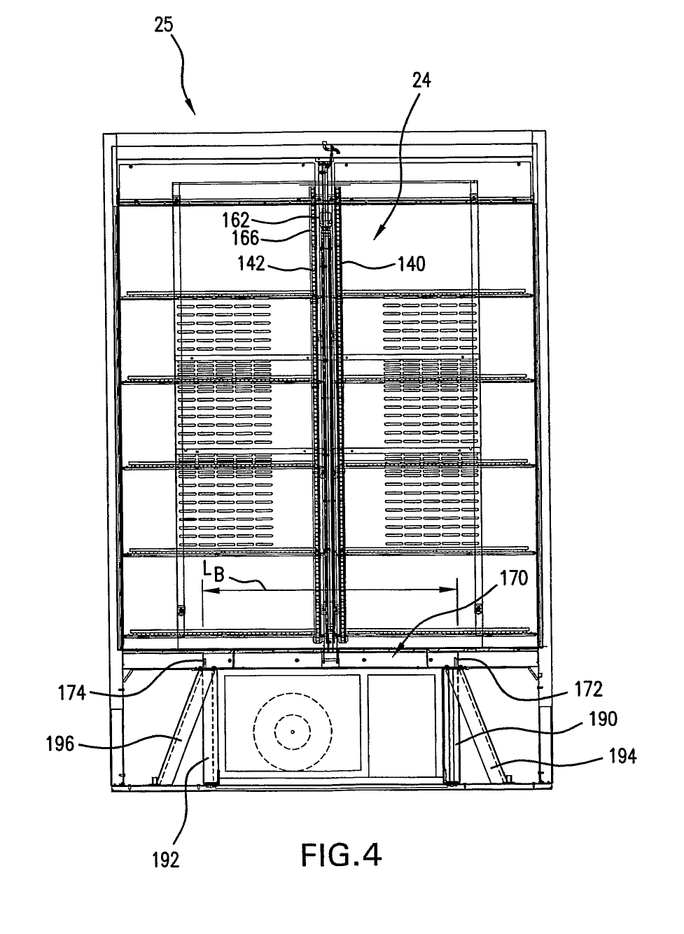

FIG. 4 shows a back intermediate support in the form of left and right tracks 140 and 142 along the back wall. Support brackets mounted along these tracks may support the adjacent inboard rear portions of the associated shelves. FIG. 3 shows a front support 150 in the form of a centerpost spaced behind the mullion 100. The post 150 has a lower end or bottom 152, an upper end or top 154, a front 156, a back 158, a left side 160, and a right side 162 (FIG. 4). Along each of the left and right sides, the post 150 bears a track 164, 166 to support inboard forward portions of the associated shelves.

It is undesirable that such posts interfere with the installation/removal and operation of the module 50. This may be particularly relevant for a front post where the module is to be installed and removed through the front. In such a situation, it may be possible for a rear post to extend behind the module to the case base within the base compartment. Supporting at least a front post without interfering with module installation/removal is therefore a concern.

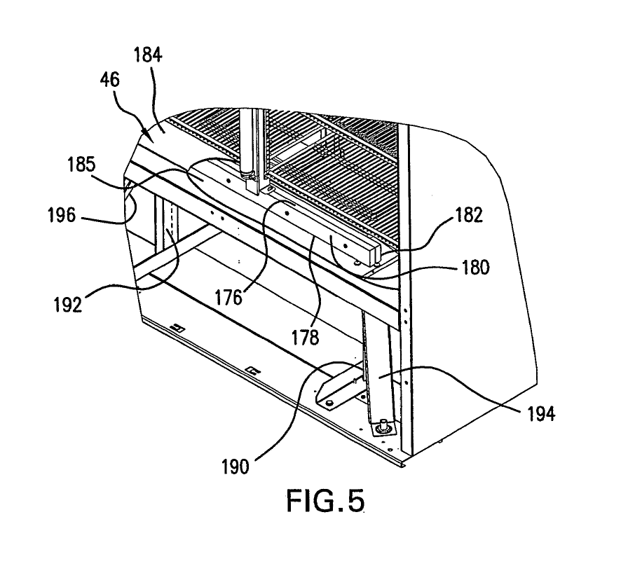

A transverse beam 170 may be used to support the post 150. The beam may be essentially full or partial case width. The exemplary beam has a length L_{B} between left and right ends 172 and 174. The exemplary beam has an upper surface 176 (FIG. 5), a lower surface or underside 178, a front 180, and a back 182. Advantageously, the beam is at least as long as the module is wide. This may provide an opening below the beam sufficiently wide to pass the module. In the exemplary implementation, the beam is a partial-width beam (there being gaps between the beam ends and the side walls) embedded within the dividing wall 46. For example, the beam may be placed between upper and lower face sheets 184 and 185 of the dividing wall and foam insulation 186 (FIG. 3) sprayed aside the beam. The lower end 152 of the exemplary post is positioned centrally atop the beam to form a structural junction/joint. In the exemplary case, a bracket 187 (FIG. 3) secures an upper end portion of the post 150 to a front header portion 188 of the case main body 25.

An exemplary beam length is 95-150% of a module width, more narrowly 105-120%. The exemplary beam is supported near its ends. Exemplary supports include vertical load carrying members and diagonal braces. FIGS. 4 and 5 show left and right vertical supports 190 and 192 and left and right diagonal supports 194 and 196. The exemplary vertical supports 190 and 192 may at least partially structurally form a module-receiving bay within the compartment 44 and may have structural features for engaging the module (e.g., to guide insertion/extraction of the module, lock the module in place, or otherwise interface with the module). To add shear stability, the exemplary diagonal braces 194 and 196 extend forward and laterally outward from their junction with the beam to a junction with the platform. As noted above, an aft/rear beam may be similarly positioned and supported. Relative to case width, beam width may vary more significantly because a given module size may be used with many case widths. Exemplary beam lengths are less than 70% of case widths (e.g., 40-60%).

Accordingly, load from the shelves is transmitted (e.g., compressively) down the post 150 to the junction with the beam 170. The load is then transmitted along the beam (e.g., shear) to the junctions with the supports and/or braces and then transmitted from the supports and/or braces to the platform and/or ground.

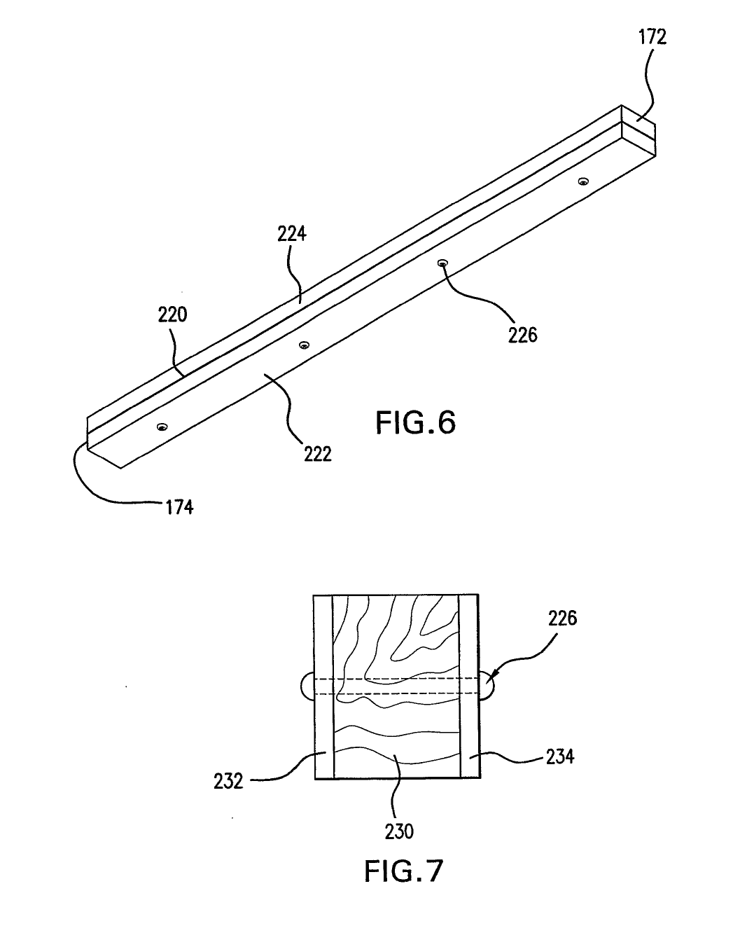

Exemplary beam constructions include metal-wood laminates. For example, a strip of metal 220 (FIG. 6) may be layered between front and back pieces of wood 222 and 224 and secured thereto by fasteners 226 (e.g., nails or threaded fasteners). Alternatively, a wood core 230 (FIG. 7) may be positioned between front and back metal pieces 232 and 234. Engineered materials (e.g., medium density fiberboard (MDF)) may also be used. For example, such materials may replace the wood in the beam. Adhesive bonding of the wood or engineered material to the metal is also possible. Exemplary metals are steel (e.g., stainless steel) and aluminum alloys. Omitting the metal is another possible variation. Non-metal beams could include wood laminates or wood-composite laminates. The use of wood or wood-based (e.g., MDF) beam material may provide a desirable combination of strength and rigidity on the one hand and insulation and manufacturability. (e.g., the ability to secure the beam to the associated components (e.g., the supports and post) via conventional fasteners (e.g., screw/bolts) on the other hand.

One or more embodiments of the present invention have been described. Nevertheless, it will be understood that various modifications may be made without departing from the spirit and scope of the invention. For example, when implemented in the reengineering or remanufacturing of an existing case configuration or case, details of the existing (baseline) configuration or case may influence details of any particular implementation. Accordingly, other embodiments are within the scope of the following claims.

What is claimed is:

1. A refrigerated case (20) comprising:
a body (22) having:
a left side (30) and a right side (32);
a top (36);
a back (34);
a refrigerated compartment (24) within the body;
a plurality of shelves (120, 122) within the refrigerated compartment;
a base compartment (44) below the refrigerated compartment;
a dividing wall (46) separating the base compartment from the refrigerated compartment; and
a refrigeration module (50) within the base compartment,
wherein:
a support member (150) intermediate the left and right sides and supporting the shelves; and
a transverse beam (170) supporting the support member.

2. The system of claim 1 wherein:
there are first and second vertical arrays of the shelves; and
the support member has first and second tracks respectively supporting the first and second arrays.

3. The system of claim 1 wherein:
the beam has left and right ends spaced apart from the left and right sides of the body and separated therefrom by foam insulation in the dividing wall.

4. The system of claim 1 wherein:
the beam is embedded in the dividing wall; and
the module is removeable through a space below the beam.

5. The system of claim 1 wherein:
the beam has a length of 40-60% of a width of the body.

6. The system of claim 1 wherein:
the beam comprises a sandwich of wood (222, 224; 230) and metal (220; 232, 234).

7. The system of claim 1 wherein:
the beam comprises at least one full-length piece of wood (222, 224; 230).

8. The system of claim 1 wherein:
the beam comprises at least one full-length piece of wood-based material (222, 224; 230).

9. The system of claim 1 wherein:
the beam comprises a combination of at least one of wood-based member (222, 224; 230) and at least one metal-based member (220; 232, 234).

10. The system of claim 1 wherein:
the beam comprises a sandwich of front and back pieces (222, 224) of wood and an intermediate piece (220) metal.

11. The case of claim 1 wherein:
the beam is supported relative to a platform by a pair of vertical supports (190, 192) and a pair of diagonal supports (194, 196).

12. The case of claim 11 wherein:
the vertical supports (190, 192) and diagonal supports (194, 196) are metallic.

13. A method for manufacturing the case of claim 1 wherein:
the beam is assembled between upper and lower face sheets (184, 185) of the dividing wall; and
foam insulation (186) is delivered between the face sheets around the beam.

14. A method for using the case of claim 1 wherein:
the module is installed or removed by passing below the beam.
